(19) United States
(12) Patent Application Publication
(10) Pub. No.: US 2024/0389004 A1
(43) Pub. Date: Nov. 21, 2024

(54) SYSTEM AND METHODS FOR ONBOARDING NETWORK DEVICES

(71) Applicant: Qorvo US, Inc., Greensboro, NC (US)

(72) Inventors: Han Wesseling, Seoul (KR); Bram Hugo Bert Van den Bosch, Schilde (BE)

(21) Appl. No.: 18/643,769

(22) Filed: Apr. 23, 2024

Related U.S. Application Data
(60) Provisional application No. 63/592,799, filed on Oct. 24, 2023.
(60) Provisional application No. 63/502,727, filed on May 17, 2023.

(51) Int. Cl. H04W 48/16

(52) U.S. Cl. CPC H04W 48/16

(57) ABSTRACT

A method for onboarding an electronic device, e.g., an Internet of things (IoT) device, in a wireless network using ultra-wideband (UWB) is provided. The method includes determining a trusted zone covered by the wireless network, and detecting an IoT device (or UWB device) in a vicinity of the trusted zone. In response to the IoT device being recognized and inside the trusted zone, the IoT device is onboarded into the wireless network.

### FIELD OF THE DISCLOSURE

This application claims priority to U.S. Provisional Patent Application No. 63/502,727 filed May 17, 2023 and U.S. Provisional Patent Application No. 63/592,799 filed Oct. 24, 2023, which are incorporated by reference herein in their entireties.

### FIELD OF THE DISCLOSURE

The present disclosure relates to ultra-wideband-enabled devices and systems for facilitating onboarding of network devices, in particular, to provide a more user-friendly way to onboard devices using ultra-wideband (UWB) technology.

### BACKGROUND

The Internet of things (IoT) are objects with sensors, processing ability, software, and other technologies that connect and exchange data with other devices and systems over the Internet or other communication networks. IoT are widely used in home automation, e.g., in a smart home, which can include lighting, heating, air conditioning, media, security systems, and camera systems. In a smart home, IoT are onboarded to a wireless local network that covers the perimeter of the home space. A user can control and manage the IoT in the wireless local network from a mobile device. The user often needs to manually add a new device into the wireless local network and configure it afterwards. For example, the wireless local network can be a wireless area network established based on network standards such as Matter, Zigbee, WiFi, IrDA, Thread, etc.

However, the existing onboarding process can be cumbersome to a user. For example, a user may need to manually scan a QR code and/or input setup codes to onboard a newly installed IoT device. The manual steps may increase user friction, and can become time consuming and impractical if many IoT devices need to be onboarded. Thus, a more user-friendly way to onboard an IoT device is needed.

### SUMMARY

Embodiments of the disclosure provide a method for onboarding an electronic device in a wireless network. The method includes determining a trusted zone covered by the wireless network, and detecting the electronic device in a vicinity of the trusted zone. In response to the electronic device being recognized and inside the trusted zone, the electronic device is onboarded into the wireless network.

In some embodiments, the determining of the trusted zone includes determining a stationary trusted zone or determining a mobile trusted zone.

In some embodiments, the determining of the stationary trusted zone includes receiving a first configuration parameter and storing the first configuration parameter in a memory; and the first configuration parameter includes at least one of a perimeter-center distance from a stationary center, and angle to the stationary center, or an angle at the stationary center.

In some embodiments, the stationary trusted zone includes at least one of an area encompassing the stationary center or an area originating from the stationary center.

In some embodiments, the receiving of the first configuration parameter includes at least one of: receiving, via a user interface (UI) widget, the perimeter-center distance and the angle at the stationary center; receiving, via the UI widget, the perimeter-center distance and the angle at the stationary center on a displayed floor map covered by the wireless network; or receiving, via the UI widget, perimeter-center distance and the angle to the stationary center on an augmented reality (AR) presentation of an area covered by the wireless network.

In some embodiments, the stationary center includes at least one of a hub, a router, a modem, a television, a set-top box, a smart speaker, or a range extender.

In some embodiments, the determining of the mobile trusted zone includes receiving a second configuration parameter and storing the second configuration parameter in a memory; and the second configuration parameter includes at least one of a perimeter-center distance from a mobile center or an angle from the mobile center.

In some embodiments, the mobile trusted zone includes at least one of an area encompassing the mobile center or an area originating from the mobile center.

In some embodiments, the mobile center includes a mobile device with an imaging device.

In some embodiments, the detecting of the electronic device includes detecting a beacon signal of the electronic device, the beacon signal including a device identification (ID) of the electronic device.

In some embodiments, the method further includes: comparing the device ID to a device information database; determining the device to be recognized in response to locating a match to the device ID in the device information database; and determining the device to be unrecognized in response to locating no match to the device ID in the device information database.

In some embodiments, in response to the electronic device being unrecognized, presenting, via a user interface (UI) widget, a prompt to onboard the electronic device using at least one of Bluetooth, near field communication (NFC), or QR code.

In some embodiments, the method further includes: in response to the electronic device being recognized, initiating a UWB ranging with the electronic device; and determining a location of the electronic device in respect with the stationary center and the mobile center based on the UWB ranging, and respective configuration parameter of each of the stationary center and the mobile center.

In some embodiments, in response to the electronic device being in at least one of the stationary trusted zone or the mobile trusted zone, presenting, via a user interface (UI) widget, a prompt to request onboarding the electronic device.

In some embodiments, in response to the electronic device being in at least one of the stationary trusted zone or the mobile trusted zone, automatically onboarding the electronic device.

In some embodiments, in response to the electronic device not being in the stationary trusted zone or the mobile trusted zone, presenting, via a user interface (UI) widget, a prompt to adjust a position of the mobile center such that the electronic device is located in the mobile trusted zone.

In some embodiments, the adjusting the position of the mobile center includes at least one of moving the mobile center towards the electronic device or changing an orientation of the mobile center to face the electronic device.

In some embodiments, the method further includes initiating another UWB ranging with the electronic device to determine a location of the electronic device with respect to the mobile center after presenting the prompt based on the UWB ranging and respective configuration parameter of the mobile trusted zone.

In some embodiments, in response to the electronic device being outside the mobile trusted zone after the prompt, presenting, via a user interface (UI) widget, another prompt to onboard the electronic device using at least one of Bluetooth, near field communication (NFC), or QR code.

In some embodiments, in response to the electronic device being in the mobile trusted zone, presenting, via the UI widget, a prompt to request onboarding the electronic device.

In some embodiments, in response to the electronic device being in the mobile trusted zone, automatically onboarding the electronic device.

In some embodiments, the electronic device comprises an ultra-wideband (UWB) device.

Embodiments of the present disclosure also provide an electronic device, which may include an ultra-wideband (UWB) device. The electronic device includes a transceiver operable to perform a UWB communication, and a memory for storing program instructions, device information, configuration parameters, angle-of-arrivals and distances from the ranging operations. The electronic device also includes a processor coupled to the transceiver and to the memory. In some embodiments, the transceiver and the processor are integrated in a single system-on-chip (SoC). The processor is operable to execute the program instructions, which, when executed by the processor, cause the electronic device to perform operations to onboard another electronic device into a wireless local network. The operations include: determining a trusted zone covered by the wireless network; detecting the other electronic device in a vicinity of the trusted zone; and in response to the other electronic device being recognized and inside the trusted zone, onboarding the other electronic device into the wireless network. In some embodiments, the electronic device includes a wireless technology other than UWB. For example, the electronic device may include Bluetooth, Thread, Wi-Fi, and so on.

In some embodiments, the determining of the trusted zone includes determining a stationary trusted zone or determining a mobile trusted zone.

In some embodiments, the determining of the stationary trusted zone includes receiving a first configuration parameter and storing the first configuration parameter in a memory; and the first configuration parameter includes at least one of a perimeter-center distance from a stationary center, and angle to the stationary center, or an angle at the stationary center.

In some embodiments, the stationary trusted zone includes at least one of an area encompassing the stationary center or an area originating from the stationary center.

In some embodiments, the receiving of the first configuration parameter includes at least one of: receiving, via a user interface (UI) widget, the perimeter-center distance and the angle at the stationary center; receiving, via the UI widget, the perimeter-center distance and the angle at the stationary center on a displayed floor map covered by the wireless network; or receiving, via the UI widget, perimeter-center distance and the angle to the stationary center on an augmented reality (AR) presentation of an area covered by the wireless network.

In some embodiments, the stationary center includes at least one of a hub, a router, a modem, a television, a set-top box, a smart speaker, or a range extender.

In some embodiments, the determining of the mobile trusted zone includes receiving a second configuration parameter and storing the second configuration parameter in a memory; and the second configuration parameter includes at least one of a perimeter-center distance from a mobile center or an angle from the mobile center.

In some embodiments, the mobile trusted zone includes at least one of an area encompassing the mobile center or an area originating from the mobile center.

In some embodiments, the mobile center includes a mobile device with an imaging device.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1A illustrates exemplary wireless communication system that includes a wireless local network, a plurality of network devices in the wireless local network, and a mobile device communicatively coupled to the wireless local network, according to some aspects of the present disclosure.

FIG. 1B illustrates a block diagram of an exemplary mobile device configured for UWB communication, according to some aspects of the present disclosure.

FIG. 1C illustrates a block diagram of an exemplary network device configured for UWB communication, according to some aspects of the present disclosure.

FIG. 1D illustrates a signaling diagram between two UWB devices, according to some aspects of the present disclosure.

FIG. 1E illustrates another signaling diagram between two UWB devices, according to some aspects of the present disclosure.

FIG. 2A illustrates an exemplary environment for onboarding a network device, according to some aspects of the present disclosure.

FIGS. 2B-2D illustrate exemplary stationary trusted zones, according to some aspects of the present disclosure.

FIGS. 2E and 2F illustrate exemplary mobile trusted zones, according to some aspects of the present disclosure.

FIGS. 3A-3C illustrate exemplary displays on a UI widget for configuring a trusted zone, according to some aspects of the present disclosure.

FIG. 4A illustrates an exemplary signaling diagram for onboarding a network device, according to some aspects of the present disclosure.

FIG. 4B illustrates a process flow for onboarding a network device corresponding to the signaling diagram of FIG. 4A, according to some aspects of the present disclosure.

FIGS. 5A-5D illustrate exemplary displays on a UI widget for onboarding a network device, according to some aspects of the present disclosure.

FIG. 6 illustrates a flowchart of an exemplary method for onboarding a network device, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several hundreds of MHz to several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance and/or angle between two devices or accurate position estimation of a device based on the distance from fixed devices (whose positions are known, also referred to as anchor devices). The present disclosure assumes that the user is carrying a device capable of communicating through UWB (referred to as “UWB-enabled user device” or simply user device). In this disclosure, a UWB device may be referred to as an IoT device equipped with UWB in a wireless network.

In home automation, IoT are controlled and managed in a wireless local network, which is often a wireless area network. The wireless local network is established based on certain internet protocol(s) such as Matter, Zigbee, Thread, Bluetooth or Bluetooth low energy (BLE), WiFi, IrDA, etc. For example, Matter is an emerging application-layer connectivity standard designed to enable developers to increase the compatibility amongst the IoT in a wireless local network. Onboarding IoT devices, the act of adding new devices into an existing network and making these devices accessible for monitoring and control through a user interface (UI) widget, is a fundamental feature in IoT networking standards. To meet security requirements, existing IoT network standards often involve manual steps for onboarding new devices. For example, in Matter, the onboarding flow typically requires the manual scanning of a QR code for an IoT device that needs to be onboarded. Other methods that circumvent QR code scanning will still require a user to trigger device discovery, select a device and input an onboarding payload (e.g., setup code). Near field communication (NFC) can simplify the flow but still requires physical access to the device. Whereas users expect increasingly seamless experiences, these manual steps increase user friction, and can become highly time consuming and impractical if many IoT devices need to be onboarded in one go.

Embodiments of the present disclosure provide a system and methods that minimize a user's input/intervention when onboarding a network device (e.g., an IoT device), and provide a more user-friendly and seamless onboarding experience. In the present disclosure, a trusted zone is set up and configured by a user. The trusted zone provides an option for a user to simplify the onboarding process based on the user's preference. For example, if a network device is located in the trusted zone, the system may onboard the network device automatically or only require the user's confirmation for onboarding. The system may discover the network device, search for device information of the network device, determine the network device's location with respect to the trusted zone based on UWB technology such as angle-of-arrival and/or ranging. If the network device is recognized but outside the trusted zone, the system may prompt the user to confirm intent to onboard the network device. If the network device is unrecognized and outside the trusted zone, the system may notify the user to onboard the network device through a way without the use of the trusted zone (e.g., a more conventional way such as scanning QR code, etc.). In various embodiments, the trusted zone includes a stationary trusted zone and a mobile trusted zone. The stationary trusted zone is located surrounding or originated from a stationary center, such as a stationary UWB device (e.g., a network control device). As an example, the stationary UWB device may include a home hub. The mobile trusted zone is located surrounding or originated from a mobile center, such as a mobile device. Depending on the location of the IoT, the system may resort to the stationary trusted zone and/or the mobile trusted zone for onboarding for various scenarios. Detailed description is provided in this disclosure.

The disclosed system and method can minimize user intervention in onboarding by utilizing the location of the to-be-onboarded device (e.g., a network device) using UWB technology. In some embodiments, based on the user's configuration or preference, onboarding can take place with minimal manual actions (e.g., in the background or only requiring minimum user confirmation). Security of the onboarding may be maintained by introducing manual steps only when necessary (or according to the user's preference/configuration) and in a way that presents less friction than existing onboarding methods. The location of the device can be determined in desirably high accuracy and security in real-time by using UWB technology such as AoA and/or ranging (e.g., two-way ranging or TWR). The provided technical solution can significantly reduce the time and effort required for onboarding multiple devices. In the present disclosure, the to-be-onboarded devices may not need to be within close physical range of the user (i.e., as may be required for a button press, NFC tap, or QR code scan) and therefore facilitate onboarding of devices that are in hard-to-reach places.

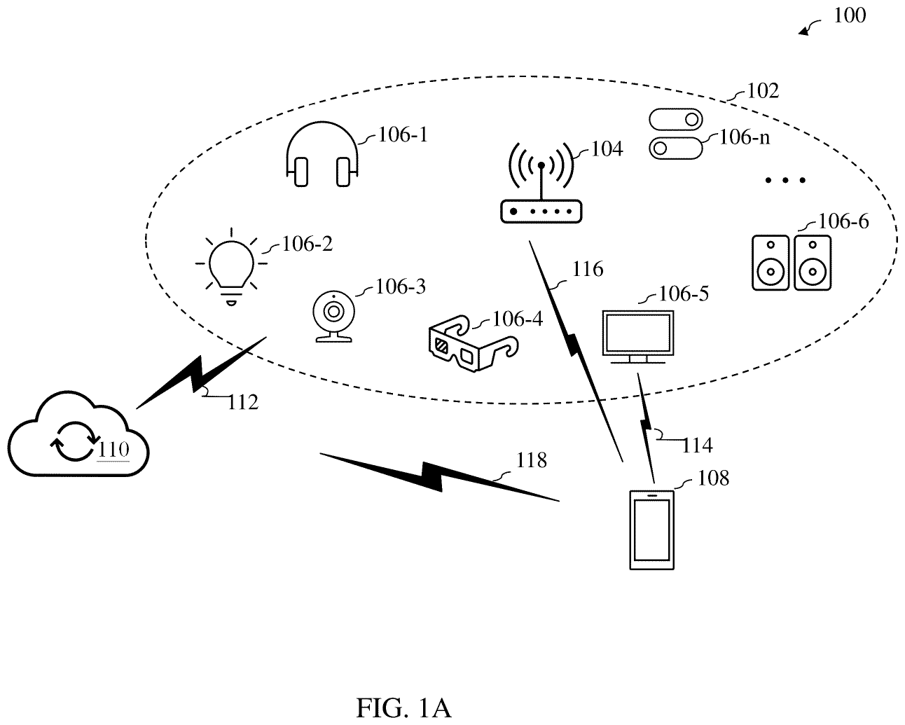

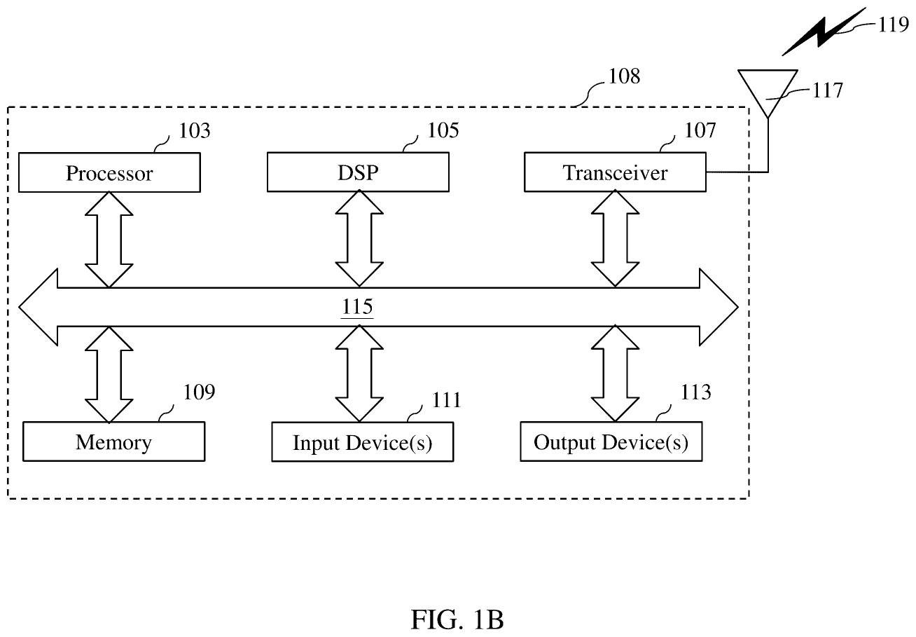

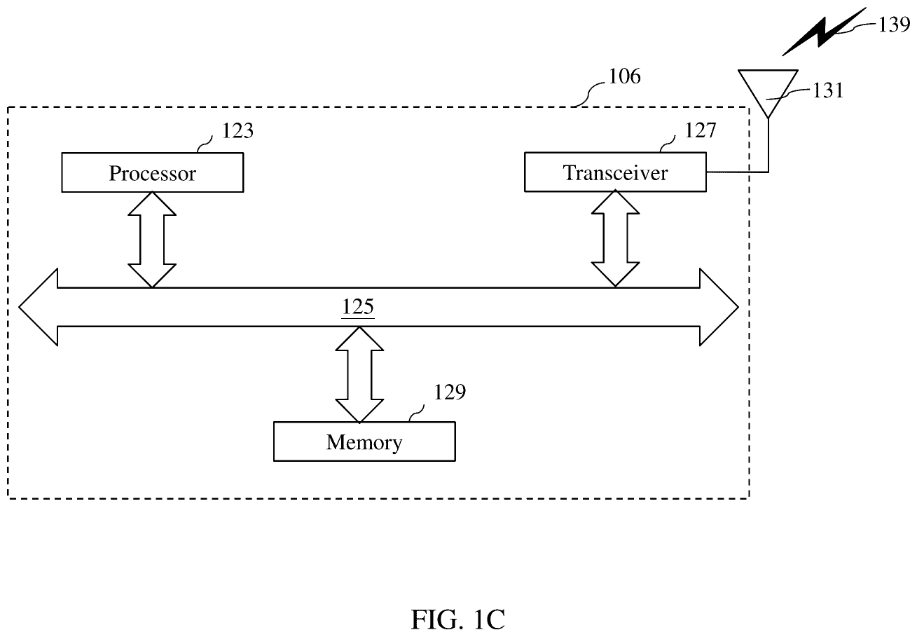

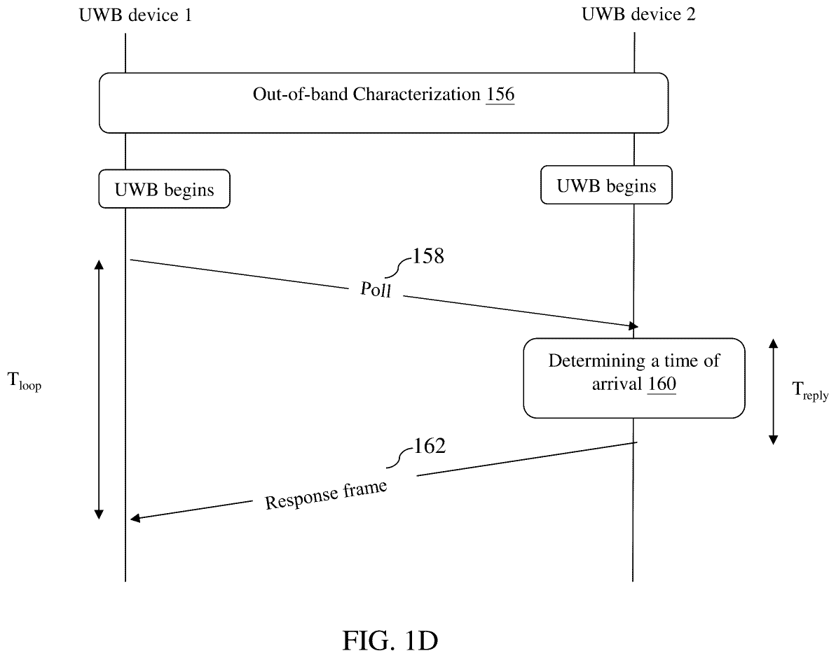

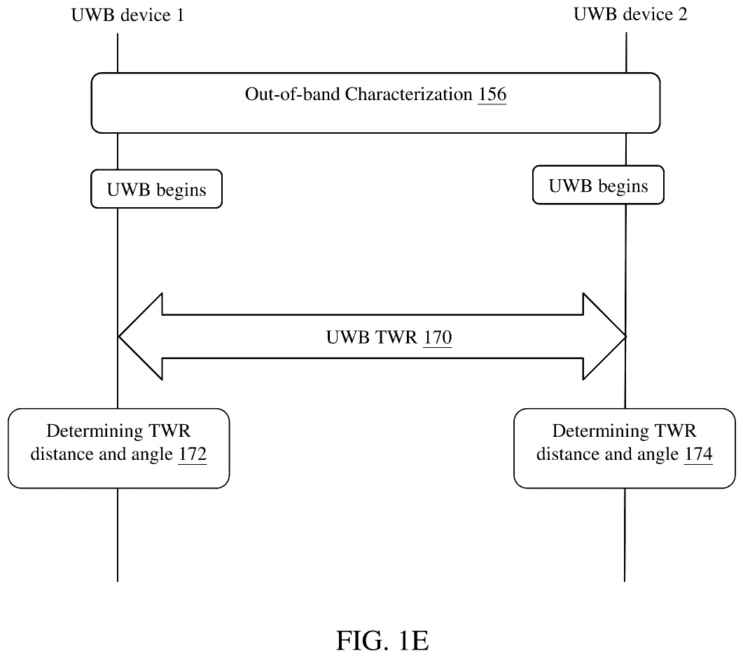

FIG. 1A is a diagram illustrating an example communication system 100 that includes a wireless local network, network devices in the wireless local network, and a mobile device communicatively coupled to the wireless local network, according to an example embodiment of the present disclosure.

Wireless local network 102 may include a network control device 104 and a plurality of network devices 106-1, 106-2, . . . , 106-n. Wireless local network 102 may be any wireless area network such as an automation network in a residential area, a hospital, a commercial building, a factory plant, a playground, a school, or the like. For ease of illustration, a home automation network is illustrated as examples in this disclosure. Network devices 106-1, . . . , 106-n may include a plurality of network devices that allow a user to access, control, and/or configure through mobile device 108. In some embodiments, network devices 106-1, . . . , 106-n may include a plurality of IoT devices, which may be to-be-onboarded devices equipped with UWB transceivers. The IoT devices (e.g., one or more of network devices 106-1, . . . , 106-n) may have the same IoT connectivity as network control device 104, and may be programmed with a unique device identification number (ID). Mobile device 108 may be a “User Equipment” capable of voice and/or data communication. Mobile device 108 may have built-in software and hardware that enable mobile device 108 to communicate with network control device 104, network devices 106-1, . . . , 106-n, and/or cloud network 110 via radio signals. In some embodiments, mobile device 108 includes a UWB transceiver configured for UWB functions and/or data transfer. Mobile device 108 may include a cellular telephone, a smartphone, a laptop computer, a tablet, a personal digital assistant (PDA), a computing device, wearable devices (e.g., a smart watch, or the like), or any other mobile device having wireless connection capability. In some embodiments, mobile device 108 may be equipped with UWB functions and support for onboarding through an application/UI widget. Mobile device 108 may include a display and may be used as a UI widget for configuring a trusted zone and any additional verification of intent to onboard. In some embodiments, mobile device 108 may serve the role of network control device 104 for onboarding. Although only a single mobile device 108 is shown in FIG. 1A, one of ordinary skill in the art will appreciate that multiple mobile devices may connect with the network devices 106-1, . . . , 106-n. A user may interact with network devices 106-1, . . . , 106-n using an application, a web browser, a proprietary program, or any other program executed and operated by the mobile device 108. In some embodiments, mobile device 108 may communicate directly with the network devices 106-1, . . . , 106-n (e.g., via communication link 114). In some embodiments, mobile device 108 may communicate with the network devices 106-1, . . . , 106-n via network control device 104 (e.g., via communication link 116) and/or the cloud network 110 (e.g., via communication link 118).

Network control device 104 has its radio communication range formed in a radio communication scheme. The communication range may cover a perimeter such as a house, a commercial building, a hospital, a playground, etc. For instance, network control device 104 may communicate data and signals with network devices 106-1, 106-2, . . . , 106-n located within the radio communication range as denoted by the dotted line using one or more radio communication schemes. Network control device 104 may also be communicatively connected to a cloud network 110 through wired/wireless communication link 112, and communicatively connected to a mobile device 108 through communication link 116. In some embodiments, network control device 104 may use a wired communication protocol and/or wireless communication protocols. Network control device 104 may acquire device information and device status information from network devices 106-1, . . . , 106-n located in the radio communication range and provide to cloud network 110 with the acquired information. Network control device 104 may also provide cloud network 110 with network control device information and network control device status information. In some embodiments, network control device 104 has wireless communication functions, and may include, but not limited to, one or more of a gateway, a hub, a television, a router, a modem, a range extender, a set-top box, a smart speaker, a mobile device (e.g., tablet, mobile phone), and/or the like. In some embodiments, network control device 104 may be a stationary device, and may be equipped with UWB functions and IoT connectivity (e.g., BLE, Thread). Network control device 104 may be used to establish a trusted zone, and determine whether a network device is inside/outside the trusted zone. In some embodiments, network control device 104 includes one or more home hubs. For example, network control device 104 may include a gateway that allows data to flow from wireless local network 102 to cloud network 110, or vice versa. In some embodiments, network control device 104 communicates using more than one internet protocol (IP) to connect wireless local network 102 and cloud network 110. In various embodiments, the network control device 104 communicates in IP's such as Matter, Zigbee, Bluetooth or BLE, WiFi, IrDA, Thread, etc.

Network devices 106-1, . . . , 106-n may transmit device information and device status information to network control device 104 and/or mobile device 108. Network devices 106-1, . . . , 106-n may each have built-in software and hardware that enable each network device to communicate with mobile device 108, and/or network control device 104 via radio signals such as UWB, WiFi, BLE, NFC, or the like. In some embodiments, each of network devices 106-1, . . . , 106-n includes a UWB transceiver configured for ranging and/or data transfer. For example, network devices 106-1, . . . , 106-n may include a headphone (e.g., 106-1), a light bulb (e.g., 106-2), a camera (e.g., 106-3), an augmented/virtual reality (AR/VR) device (e.g., 106-4), a television (e.g., 106-5), a speaker (e.g., 106-6), . . . , and a switch (e.g., 106-n).

Network control device 104 may also provide the mobile device 108 and the network devices 106-1, . . . , 106-n with access to one or more external networks, such as the cloud network 110, the Internet, and/or other wide area networks. Cloud network 110 may include a cloud infrastructure system that provides cloud services. In certain embodiments, services provided by cloud network 110 may include registration and access control of network devices 106-1, . . . , 106-n. Cloud network 110 may include one or more computers, servers, and/or systems. In some embodiments, cloud network 110 may include an application server that hosts an application, and a user may order and use the application via communication link 112. In some embodiments, wireless links 114 and 116 may each include a UWB communication interface. Wireless links 114 and 116 may also support other types of wireless connections, such as a Bluetooth communication interface, a Thread communication interface, a Wi-Fi communication interface, a cellular network connection (e.g., 4G, 5G) interface, a near field communication (NFC) interface, a ZigBee communication interface, or a combination thereof. In some embodiments, cloud network 110 may be stored with device information (e.g., device keys, vendor information, device type, etc.) of network devices 106-1, . . . , 106-n. The device information of each network device may correspond to a unique device ID of the network device. In some embodiments, the device IDs stored in a device information database such as a vendor-specific database and/or a distributed certificate ledger (DCL). The database and/or the DCL may be accessible to network control device 104 and/or mobile device 108.

Upon being powered on or reset, network devices 106-1, . . . , 106-n may be registered with the cloud network 110 and associated with a logical network within wireless local network 102. It should be appreciated that the wireless local network 102 may include other components than those depicted, and the specific number of components and/or their arrangement is not limited by the description of FIG. 1A.

FIG. 1B illustrates an example of mobile device 108. Mobile device 108 may be a cellular telephone, a smartphone, a laptop computer, a tablet, a personal digital assistant (PDA), a computing device, or any other mobile device having wireless connection capability. In some embodiments, mobile device 108 includes a processor 103, a digital signal processor (DSP) 105, a transceiver 107, an antenna 117, a memory 109, an input device 111, an output device 113, and a bus 115. The hardware components of mobile device 108 may be communicatively coupled to bus 115. In some embodiments, bus 115 can be used for processor 103 to communicate between cores and/or with memory 109. Processor 103 may include one or more general-purpose processors and/or one or more special-purpose processors (such as digital signal processing chips, graphics acceleration processors, and/or the like). Processor 103 may process wireless signals 119 received by transceiver 107, such as ranging signal/data from UWB communication. Input device 111 may include a camera, a mouse, a keyboard, a touch sensitive screen/display, a touch pad, a keypad, and/or the like. An output device 113 may include a display, a printer, and/or the like. In some embodiments, a user may load an onboarding application, which automatically turns on the camera, which has a field of view (FOV). In some embodiments, a user may receive AR elements/indicators on output device 113 (e.g., a UI widget or a display), and may input a user's response on input device 111 (e.g., the user interface widget or display).

Mobile device 108 may include a transceiver 107 communicatively coupled to bus 115. Transceiver 107, a UWB transceiver, may be operable to transmit and receive wireless signals 119 via antenna 117. Wireless signals 119 may be transmitted/received via a wireless network. In some embodiments, the wireless network may be any wireless network such as a wireless local network (e.g., wireless local network 102), such as WiFi, a Personal Access Network (PAN), such as Matter, Thread, Bluetooth® or Zigbee®, or a cellular network (e.g., 4G, 5G). Transceiver 107 may be configured to receive signals 119 via antenna 117 from a network control device (e.g., 104), network devices (e.g., 106-1, . . . , 106-n), a cloud network (e.g., 110), and/or the like. Mobile device 108 may also be configured to decode and/or decrypt, via the DSP 105 and/or processor 103, various signals received from network control device 104, network devices 106-1, . . . , 106-n, cloud network 110, and/or the like.

Memory 109 may include one or more non-transitory storage devices that can include local and/or network accessible storage, a disk drive, a drive array, an optical storage device, a solid-state storage device such as a random access memory (“RAM”) and/or a read-only memory (“ROM”), a programmable ROM, a flash-updateable ROM, and/or the like. Such storage devices may be configured to implement any appropriate data storage, including without limitation, various file systems, database structures, and/or the like. In some embodiments, memory 109 may be stored with a device database, including device information (e.g., device identification (ID), device keys, vendor information, device type, etc.) of one or more of network devices 106-1, . . . , 106-n.

In various embodiments, functions/operations may be stored as one or more instructions or code in memory 109, such as on a computer-readable storage medium, such as RAM, ROM, FLASH, or disc drive, and executed by processor 103 or DSP 105. Mobile device 108 may also include software components (e.g., located within memory 109), including, for example, an operating system, device drivers, executable libraries, and/or other executable code, such as one or more application programs. The application programs may include computer programs, stored in memory 109, executed by processor 103 and/or DSP 105 to implement various functions under the control of the operating system. The computer programs may have been pre-packaged with mobile device 108 or may have been downloaded by a user into memory 109 of the mobile device 108. Some mobile applications may be more user-interactive applications, such as an application to onboard a network device and an AR application to show a network device in the background, whereas some other mobile applications may be less user-interactive in nature.

FIG. 1C illustrates an example of a network device 106, which may represent any one of network devices 106-1, . . . , 106-n. Network device 106 may include a transceiver 127, e.g., a UWB transceiver, and an antenna 131 (communicatively coupled to transceiver 127) for wireless communication with mobile device 108 and/or network control device 104. Depending on the type, network device 106 may optionally include a processor 123, a memory 129, and a bus 125.

Transceiver 127 may be operable to transmit and receive wireless signals 139 via antenna 131. Wireless signals 139 may be transmitted/received via a wireless network. In some embodiments, the wireless network may be any wireless network such as a wireless local network (e.g., wireless local network 102), such as WiFi, a Personal Access Network (PAN), such as Matter, Bluetooth® or Zigbee®, Thread, or a cellular network (e.g., 4G, 5G). Transceiver 127 may be configured to receive wireless signals 139 via antenna 127 from a network control device (e.g., 104), a mobile device (e.g., 108), and/or the like. Optionally, network device 106 may include a DSP (not show) for decoding and/or decrypting, various received signals 139.

Optionally, network device 106 may include a processor 123 and a memory 129. Processor 123 may include one or more general-purpose processors and/or one or more special-purpose processors, similar to processor 103. Memory 129 may include one or more non-transitory storage devices, similar to memory 109. Optionally, network device 106 may include a bus 125 that communicatively couples processor 123, transceiver 127, and memory 129 such that processor 123 may execute instructions stored in memory 129 and may process signals 139 received by transceiver 127, such as ranging signal/data from UWB communication. In some embodiments, memory 129 may be stored with position information of one or more network devices, as well as configuration parameters of a trusted zone. For example, memory 129 may be stored with the position information of another network device, the bounds/perimeter of a trusted zone based on the configuration parameters, position information of mobile device 108, etc.

A user may onboard network device 106 to wireless local network 102 through mobile device 108, using an onboarding application, e.g., with AR features. In some embodiments, the AR features show the network device 106 in the environment for the user to confirm onboarding, show the environment to allow user to configure the trusted zone, etc. To onboard a network device, network control device 104 and/or mobile device 108 may perform UWB communication with a network device 106 to obtain position information of network device 106. FIG. 1D illustrates UWB communication between a UWB device 1 and a UWB device 2 using single-sided two-way ranging (SS TWR). In some embodiments, UWB device 1 may represent network control device 104 or mobile device 108, and UWB device 2 may represent network device 106. In some embodiments, UWB device 1 is an initiator of the TWR, and UWB device 2 is the responder of the TWR.

UWB device 1 may discover UWB device 2 using an out-of-band (OOB) technique, such as BLE, and may establish an OOB (e.g., BLE) channel for initial characterization 156 (e.g., negotiation and service data exchange). In some embodiments, UWB device 1 discovers UWB device 2 and establish the OOB channel using a device ID transmitted by UWB device 2 via BLE. After the initial characterization, UWB devices 1 and 2 may start UWB communications, e.g., a UWB ranging such as SS TWR. UWB device 1 may transmit a poll 158 to UWB device 2. UWB device 2 may determine a time of arrival 160 and transmit to UWB device 1 a response frame 162 after a time of reply T_{reply}. The response frame 162 may include information such as time of reply T_{reply} by UWB device 2. UWB device 1 may determine the time between the transmission of poll 158 and the receipt of response frame 162 to be Tₗₒₒₚ, and may compute a time of flight (TOF) to be (Tₗₒₒₚ−T_{reply})/2. UWB device 1 may compute a distance D between UWB device 1 and UWB device 2 to be D=TOF×speed of light. In some embodiments, UWB device 1 also determines an angle-of-arrival (AoA) based on the phase change between poll 158 and response frame 162, detected from the antenna(s) of UWB device 1 (e.g., antenna 131). That is, UWB device 1 may determine a relative position of UWB device 2 (e.g., to UWB device 1) based on distance D and the angle-of-arrival. In some embodiments, response frame 162 also includes the device ID of UWB device 2.

FIG. 1E illustrates another UWB communication between a UWB device 1 and a UWB device 2 using double-sided two-way ranging (DS TWR). Different from the SS TWR shown in FIG. 1D, in some embodiments, UWB device 1 and UWB device 2 may perform DS TWR, e.g., UWB TWR 170 and respectively determining the TWR distance and-angle-of arrival in 172 and 174. It should also be noted that, other ranging methods may also be used to determine the distance and/or angle-of-arrival between UWB devices 1 and 2, such as one-way ranging (OWR). The specific ranging method used between UWB devices 1 and 2 are not limited by the embodiments of the present disclosure.

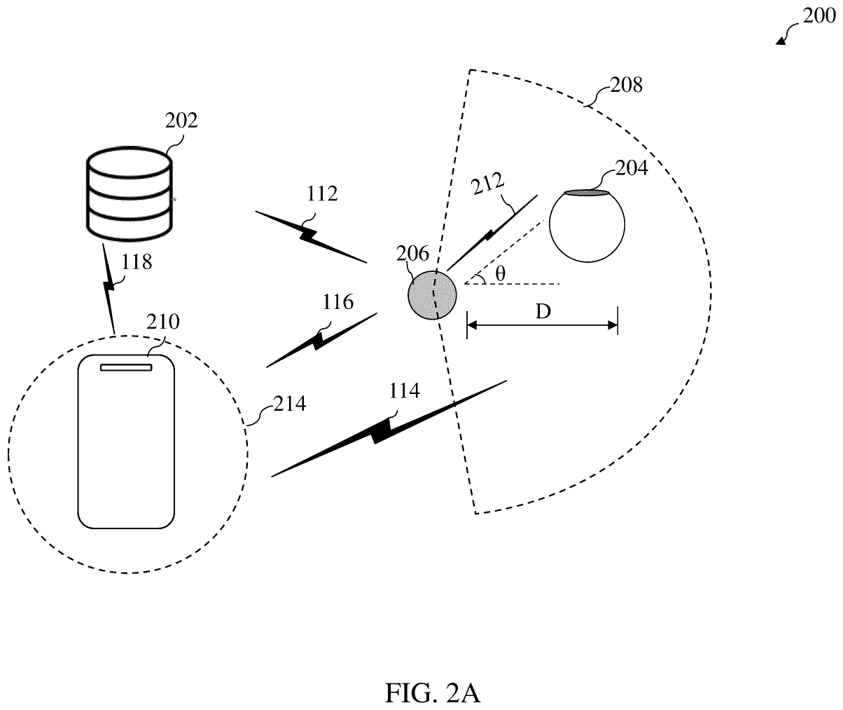

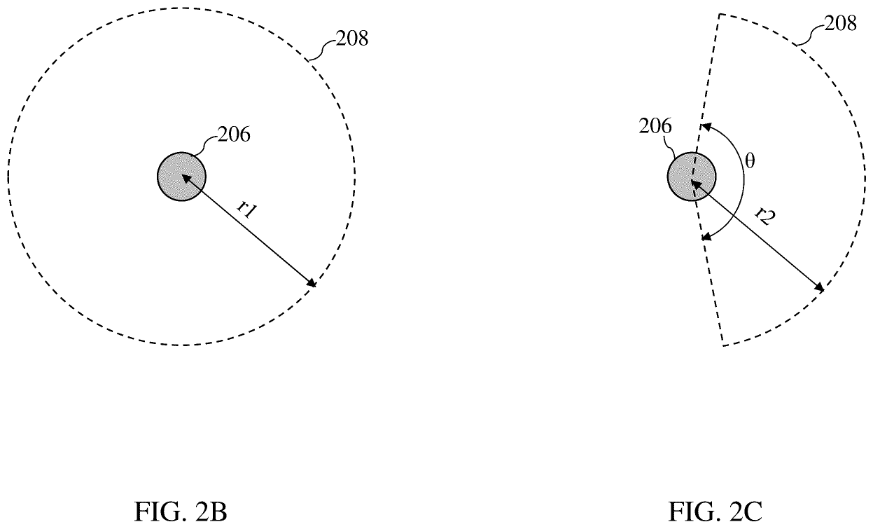

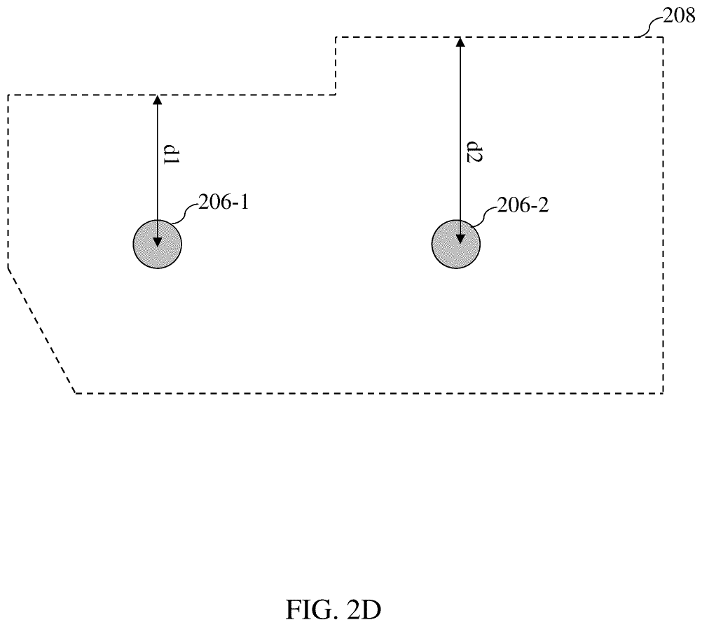

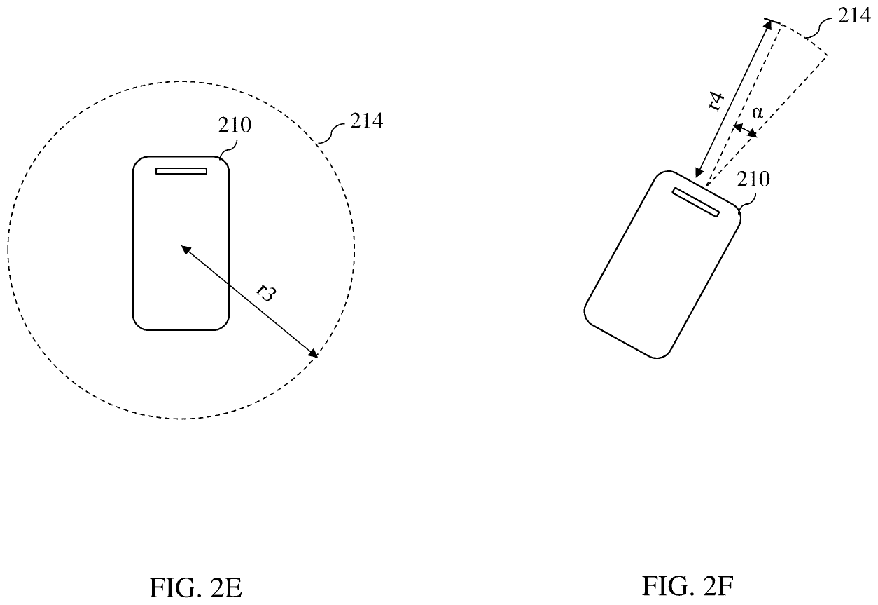

FIG. 2A illustrates an operating environment 200 in which a network device is in the vicinity of a network control device, and can be verified by a network control device and/or a mobile device for onboarding, according to some embodiments. As shown in FIG. 2A, operating environment 200 may include a network control device 206, a mobile device 210, a device information database 202, and a network device 204. Network control device 206 may be an example of network control device 104, network device 204 may be an example of network device 106, and mobile device 210 may be an example of mobile device 108. Device information database 202 may be stored in a cloud network (e.g., cloud network 110) that is communicatively coupled to network control device 206 and mobile device 210. Referring back to the description of FIG. 1A, network control device 206 may communicate with mobile device 210 via communication link 116 and may communicate with device information database 202 via communication link 112. Network device 204 may communicate with network control device 206 via a communication link 212, and may communicate with mobile device 210 via communication link 114. Mobile device 210 may communicate with device information database 202 via communication link 118. In some embodiments, communication links 114, 116, and 212 may each include various IP protocols such as Matter, Zigbee, Bluetooth or BLE, WiFi, IrDA, Thread, etc.

A trusted zone may be set up in the vicinity of network control device 206 and/or mobile device 219. In an example, network control device 206 may be a stationary center of which the position is unchanged. A stationary trusted zone 208 may be defined around or originated from the stationary center, e.g., network control device 206. Mobile device 210 may be a mobile center of which the position may change, e.g., as the user carrying mobile device 210 moves. A mobile trusted zone 214 may be defined around or originated from the mobile center, e.g., mobile device 210. In some embodiments, the trusted zone may include one or more, e.g., both, of stationary trusted zone 208 and mobile trusted zone 214. In some embodiments, the trusted zone may include one of stationary trusted zone 208 and mobile trusted zone 214. In an example, the trusted zone may include only mobile trusted zone 214, e.g., when network control device 206 is not available. In various embodiments, mobile device 210 may function independently or as a supplemental component to network control device 206. In various embodiments, mobile device 210 may detect and verify onboarding of network device 204 with or without the presence of network control device 206.

In some embodiments, if network control device 206 and/or mobile device 210 detect network device 204 in the vicinity, network control device 206 and/or mobile device 210 may check the device information of network device 204 by looking up the device ID of network device 204 in device information database 202. If a match to the device ID can be found in device information database 202, network control device 206 and/or mobile device 210 may determine network device 204 as being recognized. Network control device 206 may initiate UWB ranging to determine the position of network device 204 by determining a distance D and an AoA of network device 204 with respect to network control device 206. If network device 204 is located in stationary trusted zone 208, network control device 206 may onboard network device 204. If network device 204 is located outside stationary trusted zone 208, network control device 206 and/or mobile device 210 may determine whether network device 204 is located in mobile trusted zone 214 and confirm the user's intention to onboard. In some embodiments, the user's intention to onboard is confirmed by prompting the user to bring network device 204 within mobile trusted zone 214. Network control device 206 and/or mobile device 210 may onboard network device 204 if the user confirms onboarding by locating network device 204 in mobile trusted zone 214. Details of the operations are described below. FIGS. 2B-2F illustrate examples of stationary trusted zone 208 and mobile trusted zone 214.

FIGS. 2B-2D are examples of stationary trusted zone 208, according to some embodiments. As shown in FIG. 2B, stationary trusted zone 208 may have a circular shape centered around network control device 206 (e.g., the stationary center). Stationary trusted zone 208 may have a perimeter-to-center distance, e.g., radius, of r1, which can be a suitable distance configured by the user. In some embodiments, “perimeter-to-center” distance refers to any point on the perimeter to the geometric center of a network control device 206 or mobile device 210. As shown in FIG. 2C, stationary trusted zone 208 may have a sector shape originated from network control device 206. The sector shape may have a radius r2 and an inner angle θ. In some embodiments, the sector shape, e.g., radius r2 and inner angle θ, can be configured by the user. FIG. 2D illustrates another example of stationary trusted zone 208 which is formed by merging stationary trusted zones of more than one network control devices. As shown in FIG. 2D, two network control devices 206-1 and 206-2 are located sufficiently close to each other that the stationary trusted zones (or stationary trusted sub-zones) centered around them merge (or at least partially overlap) to form stationary trusted zone 208. In some embodiments, the stationary trusted sub-zone around network control device 206-1 may have a perimeter-to-center distance d1, and the stationary trusted sub-zone around network control device 206-2 may have a perimeter-to-center distance d2. In some embodiments, d1 and d2 may be configured by the user. In various embodiments, d1 and d2 may be the same or may be different, and may stay constant or may vary.

FIGS. 2E and 2F are examples of mobile trusted zone 214, according to some embodiments. As shown in FIG. 2E, mobile trusted zone 214 may have a circular shape centered around mobile device 210 (e.g., the mobile center). Mobile trusted zone 214 may have a perimeter-to-center distance, e.g., radius, of r3, which can be a suitable distance configured by the user. As shown in FIG. 2F, mobile trusted zone 214 may have a sector shape originated from network control device 206. The sector shape may have a radius r4 and an inner angle α. In some embodiments, the sector shape, e.g., radius r4 and inner angle α, can be configured by the user. In some embodiments, the sector shape may be originated from the front of mobile device 210, instead of the geometric center of mobile device 210. Mobile trusted zone 214 allows a user to bring mobile device 210 close to network device 204 or turn mobile device 210 such that network device 204 can be located in mobile trusted zone 214. In some embodiments, mobile trusted zone 214 is used to confirm the user's intent to onboard network device 204.

In various embodiments, stationary trusted zone 208 and/or mobile trusted zone 214 of this disclosure may have any suitable shape such as circular, rectangular, square, triangular, sector, regular, irregular, etc. Stationary trusted zone 208 and/or mobile trusted zone 214 may fully or partially surround the respective center (e.g., network control device 206 or mobile device 210), or originate from the respective center. Embodiments are not meant to limit the scope of the disclosure.

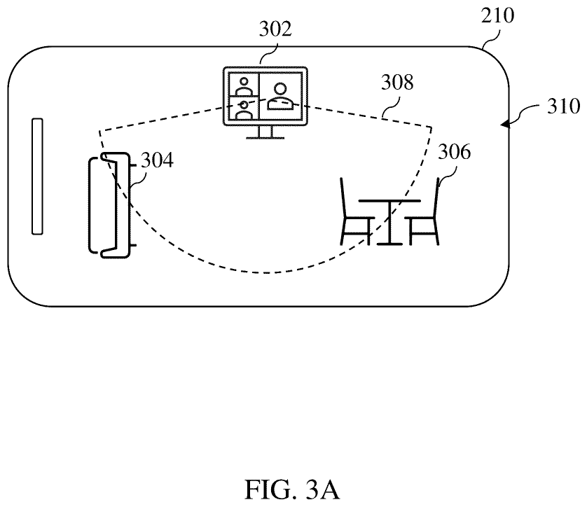

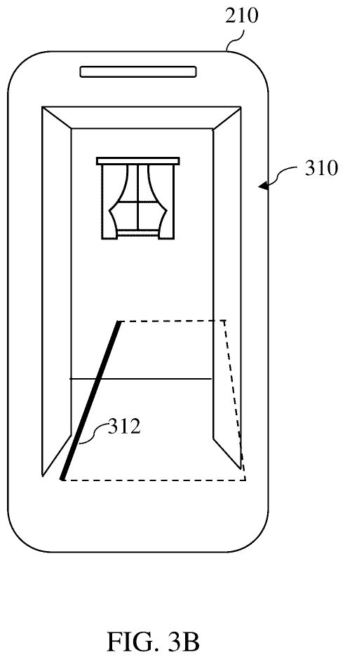

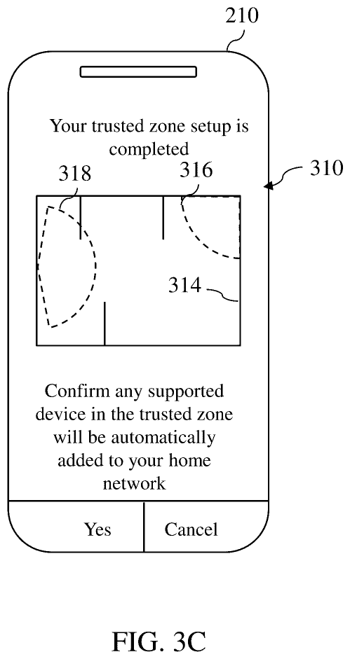

FIGS. 3A-3C illustrate examples of a user configuring a trusted zone on a UI widget, according to some embodiments. For example, the user may configure the trusted zone on the display/screen of mobile device 210, and may set any security preference for onboarding a network device. In some embodiments, the user may configure the trusted zone before onboarding any network device, and can modify the configuration at any desired time. For example, the user may configure the trusted zone only once, and may then use the configuration to onboarding various network devices.

As shown in FIG. 3A, a user may choose to configure a stationary trusted zone using mobile device 210 enabled with UWB functions with AR function, according to some embodiments. In some embodiments, mobile device 210 is also equipped with other distance-measuring technologies such as light detection and ranging (LiDAR), which may or may not be used with UWB in ranging. A user may turn on the imaging device, e.g., a camera, on mobile device 210 and turn mobile device 210 towards the network control device, e.g., a television 302, in this example. Mobile device 210 may display television 302 and any other object in the field of view (FOV) on a UI widget 310, such as furniture (e.g., a couch 304 and a table set 306). In some embodiments, mobile device 210 may display a stationary trusted zone 308 as a configurable colored area originated from the geometric center of television 302. In some embodiments, mobile device 210 may display a message on UI widget 310 to prompt the user to configure the stationary trusted zone 308. For example, although not shown, mobile device 210 may display “set your trusted zone size by dragging the colored area. You can change the radius and angle.” The user may user fingertips to change the radius and angle of stationary trusted zone 308 such that stationary trusted zone 308 may cover a desired area. Television 302 may determine the perimeter of stationary trusted zone 308 based on the user's input. Television 302 (e.g., the network control device) and/or mobile device 210 may record/store the radius and angle as configuration parameters, and may use the configuration parameters to determine a to-be-onboarded network device's position with respect to television 302 and/or mobile device 210 (e.g., the stationary center and/or the mobile center).

As shown in FIG. 3B, a user may choose to configure another stationary trusted zone using mobile device 210 enabled with UWB functions with AR function, according to some embodiments. A user may turn on the imaging device, e.g., a camera, on mobile device 210 and turn mobile device 210 towards an area the user would like to configure. UI widget 310 may show any objects (e.g., walls, floor, furniture) in the FOV, and receive the user's input as hand drawing on UI widget 310. For example, although not shown, mobile device 210 may display “set your trusted zone size by drawing a line through your home.” The user may draw a line 312 on UI widget 310 as the boundary/perimeter of a stationary trusted zone. In some embodiments, line 312 may be straight and/or curved, and may be editable to change its length and orientation. The network control device (not shown) may determine the perimeter of the stationary trusted zone based on the location of mobile device 210 and the user's input using a suitable algorithm such as triangulation. The network control device and/or mobile device 210 may record/store the length and/or orientation of line 312 as configuration parameters, and may use the configuration parameters to determine a to-be-onboarded network device's position with respect to the network control device and/or mobile device 210 (e.g., the stationary center and/or the mobile center).

As shown in FIG. 3C, a user may choose to configure another stationary trusted zone using mobile device 210 by drawing/selecting on a floor map of the area the user would like to configure, according to some embodiments. A user may open a floor map 314 (e.g., pre-stored in mobile device 210 and/or cloud network 110) that shows the floor plan of the area the user would like to configure. The user may use fingertips to tap or draw one or more stationary trusted zones 316 and 318 surrounding respective network control devices. The network control device(s) (not shown) may determine the perimeter of the stationary trusted zone based on the dimensions provided by floor map 314 and the user's input. The network control device(s) and/or mobile device 210 may record/store any distances (e.g., radii) and angles as configuration parameters, and may use the configuration parameters to determine a to-be-onboarded network device's position with respect to the network control device(s) and/or mobile device 210 (e.g., the stationary center and/or the mobile center).

In some embodiments, although not shown, a stationary trusted zone may not surround or originate from the stationary center (e.g., the network control device). For example, the stationary trusted zone may be defined to be in the vicinity of the stationary center, and the user may determine the stationary trusted zone by entering/customizing the area using fingertips on the UI widget of the mobile device, similar to the examples illustrated in FIGS. 3A-3C. Based on the user's input, the network control device may determine the stationary trusted zone using a suitable algorithm such as triangulation based on the location of mobile device 210 and the user's input. In various embodiments, the stationary trusted zone may be determined using any of the configuration methods illustrated in FIGS. 3A-3C, such as AR-assisted, hand drawing, and/or using a floor map.

In some embodiments, although not shown, the user may also input the radius and the angle for the mobile trusted zone (referring back to the description of FIGS. 2E and 2F). The network control device and/or mobile device 210 may record/store the radius and the angle as configuration parameters, and may use the configuration parameters to determine a to-be-onboarded network device's position with respect to the mobile device 210 (e.g., the stationary center and/or the mobile center).

In some embodiments, as shown in FIG. 3C, after the user has entered the configuration parameters, mobile device 210 may notify the user that “Your trusted zone setup is completed.” In some embodiments, mobile device 210 may also ask for the user's consent to onboard network devices without further interaction. For example, as shown in FIG. 3C, mobile device 210 may display on UI widget 310 that “Confirm any supported device in the trusted zone will be automatically added to your home network.” The user may select “Yes” for confirming automatic onboarding, or “No” for requiring user confirmation.

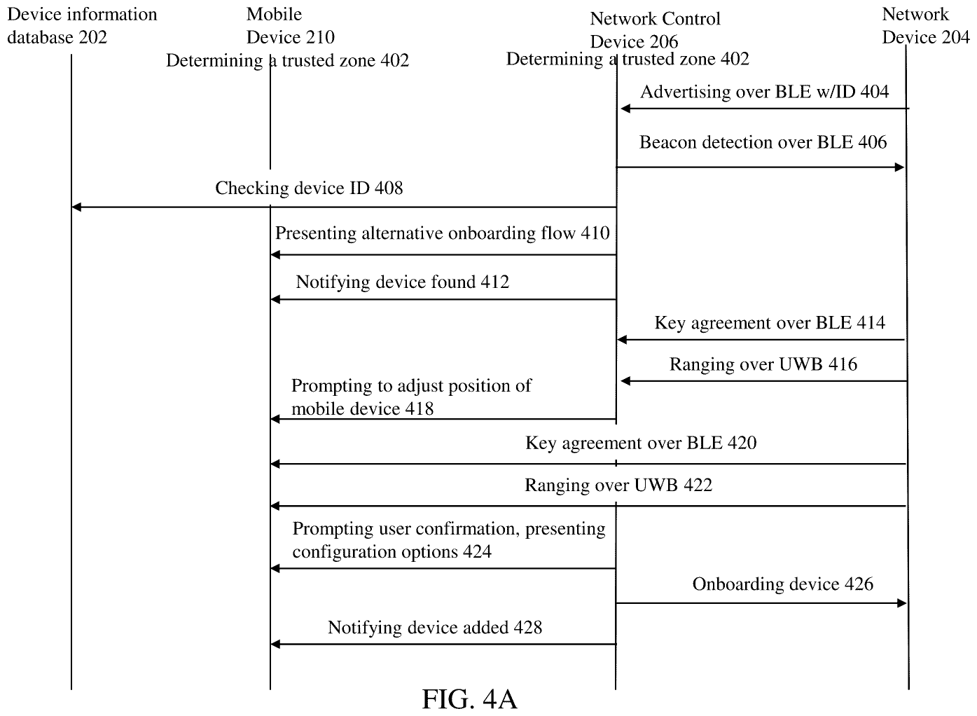

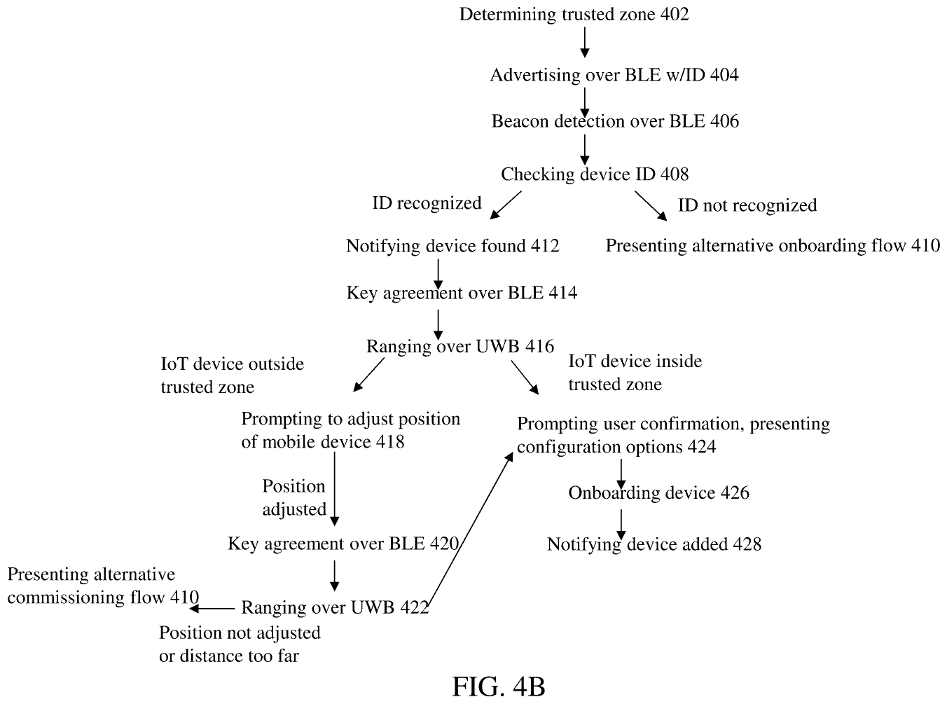

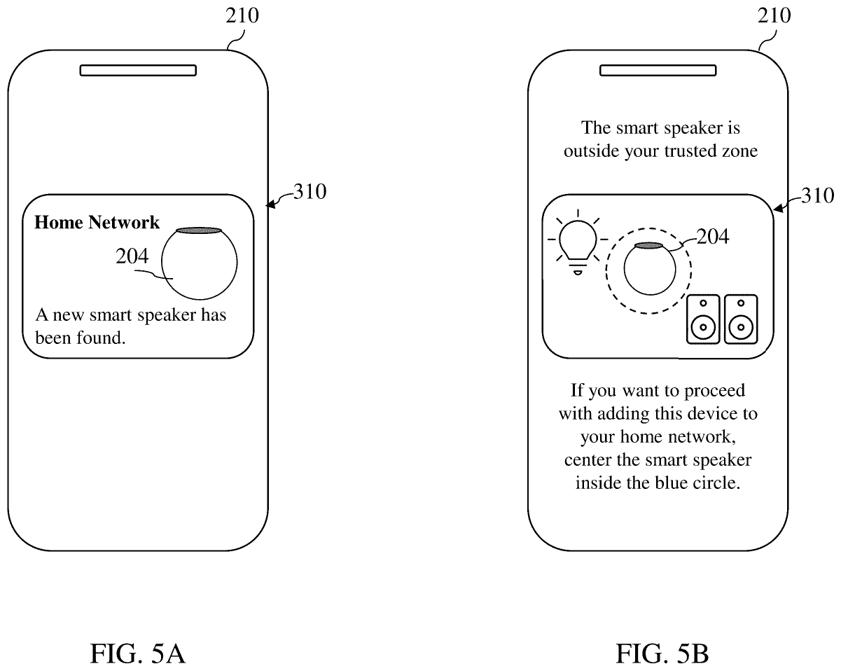

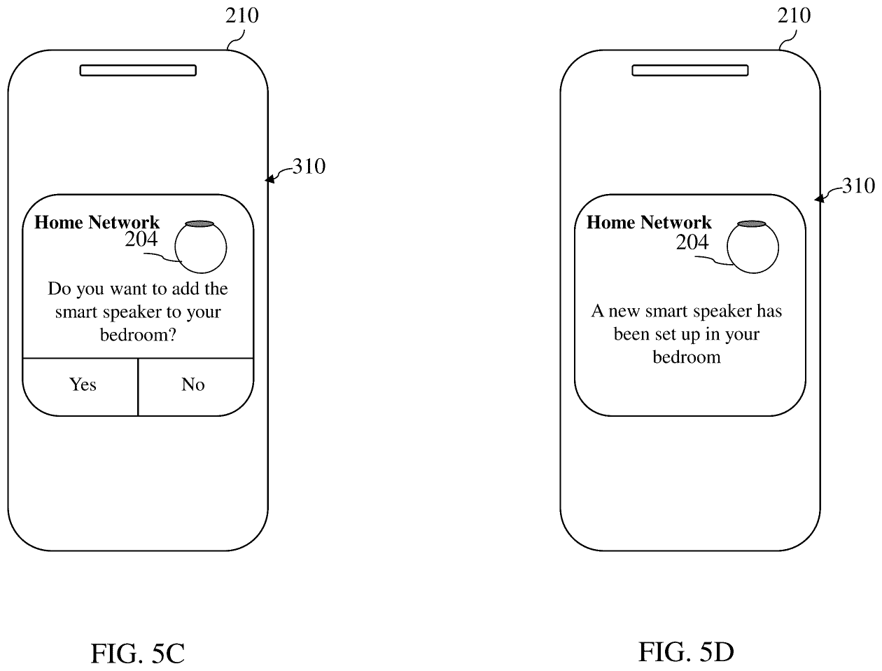

FIG. 4A shows a signaling diagram amongst device information database 202, mobile device 210, network control device 206, and network device 204, according to some embodiments. FIG. 4B illustrates the process flow of the operations in FIG. 4A. FIGS. 5A-5D illustrate examples of the displays on UI widget 310 of mobile device 210 when onboarding network device 204, according to some embodiments. For ease of illustration, FIGS. 4A, 4B, and 5A-5D are described together.

At step 402, a trusted zone is determined by network control device 206 and/or mobile device 210. In some embodiments, the trusted zone includes a stationary trusted zone (e.g., 208) and/or a mobile trusted zone (e.g., 214). A user may configure the area/coverage on mobile device 210, and the configuration parameters of the trusted zone may be stored on network control device 206, mobile device 210, and/or cloud network 110. Details of the trusted zone and the configuration process may be referred to the description of FIGS. 2A-2D and 3A-3C, and are not repeated herein.

At step 404, network device 204, e.g., a to-be-onboarded IoT device, may be powered on, and may advertise its presence by transmitting BLE beacons (and/or through other wireless technologies) containing its unique device ID. The device ID may include device information such as vendor information, product information, and unique identifier fields.

At step 406, network control device 206, e.g., a home hub, may detect the device ID of network device 204 by scanning for BLE beacons.

At step 408, network control device 206 may check the device ID in device information database 202, which may include a direct communications link (DCL) or vendor-specific database. If no match is found for the device ID in device information database 202, network control device 206 may determine the device ID (e.g., and network device 204) to be not recognized.

If the device ID is not recognized, network device 206 may trigger mobile device 210 to prompt the user to start onboarding network device 204 using an existing IoT standard onboarding flow in step 410, such as requesting of manual verification of onboarding payload (in the case of Matter, scanning a QR code).

If the device ID is recognized, network control device 206 may trigger mobile device 210 to notify the user network device 204, e.g., a specific product from a specific vendor has been found at step 412. For example, mobile device 210 may display the device information of network device 204 on the UI widget (e.g., 310) for the user to view. As shown in FIG. 5A, network device 204 may be a smart speaker, and mobile device 210 may notify the user “A new smart speaker has been found.”

At step 414, network control device 206 and network device 204 may then proceed to agreement on session keys over BLE (and/or other wireless technologies) by using an anonymous authentication key agreement scheme.

At step 416, network control device 206 and network device 204 may use negotiated sessions keys, along with ranging session parameters, to start a secure UWB ranging session, using TWR and/or AoA. In some embodiments, network control device 206 may determine a distance and an angle between network control device 206 and network device 204. In some embodiments, network control device 206 is the initiator of the UWB ranging session and network device 204 is the responder. Based on the result of the ranging session, network control device 206 may determine the relative positions between stationary trusted zone 208 and network device 204 based on the result of the ranging session and the configuration parameters of the stationary trusted zone 208.

If network device 204 is determined to be located outside of stationary trusted zone 208, network control device 206 may trigger mobile device 210 to prompt the user via UI widget 310 to adjust the position of mobile device 210, e.g., bring mobile device 210 closer to network device 204 such that network device 204 can be within the mobile trusted zone 214, in step 418. In some embodiments, mobile device 210 may display guidance and/or instructions on UI widget 310 to prompt the user to move/rotate mobile device 210 towards a certain direction. In some embodiments, the instructions may prompt the user to move mobile device 210 towards a certain direction by a determined distance. In some embodiments, additionally or alternatively, the instructions may prompt the user to rotate mobile device 210 by a determined angle such that mobile device 210 can be pointing at network device 204. Referring back to the description of FIGS. 2E and 2F, if the user has an intent to onboard network device 204, the user may adjust the position of mobile device 210 such that network device 204 is located in the radius of r3 (for scenario in FIG. 2E) or in the radius of r4 and angle a (for scenario in FIG. 2F). In an example, as shown in FIG. 5B, mobile device 210 may notify the user “The smart speaker is outside your trusted zone” and “If you want to proceed with adding this device to your home network, center the smart speaker inside the blue circle.” To center the smart speaker, the user may need to move and/or rotate mobile device 210 such that the smart speaker can be located in mobile trusted zone 214 (e.g., shown in FIGS. 2E and 2F). In some embodiments, device manufacturers may mandate the use of the mobile trusted zone 214 as second step even if network device 204 is determined to be located inside the stationary trusted zone 208.

In step 420, mobile device 210 and network device 204 may agree on session keys over BLE (and/or other wireless technologies) using an anonymous authentication key agreement scheme.

In step 422, mobile device 210 and network device 204 may start a secure UWB ranging session, using TWR and/or AoA. In some embodiments, mobile device 210 may determine a distance and an angle between mobile device 210 and network device 204. In some embodiments, mobile device 210 is the initiator of the UWB ranging session and network device 204 is the responder. Based on the result of the ranging session, mobile device 210 may determine the relative positions between mobile trusted zone 214 and network device 204 based on the result of the ranging session and the configuration parameters of mobile trusted zone 214. Step 422 may be used to verify whether the user actually intends to onboard network device 204 being pointed at, and not a Man-in-the-Middle impersonating a to-be-onboarded device. If the verification fails (e.g., the distance is too large that network device 204 is located outside mobile trusted zone 214), the operations proceed to step 410, which prompts the user, on UI widget 310, to onboard network device 204 using an alternative onboarding flow such as scanning a QR code.

If network control device 206 and/or mobile device 210 determines network device 204 inside mobile trusted zone 214 or the validation is successful, network control device 206 may trigger mobile device 210 to prompt a confirmation in a notification menu to the user on UI widget 310 to notify the user that network device 204 can be added/onboarded, in step 424. In some embodiments, mobile device 210 may present configuration options to the user on UI widget 310 with the confirmation. For example, as shown in FIG. 5C, mobile device 210 may display “Do you want to add the smart speaker to your bedroom?” on UI widget 310. In some embodiments, the confirmation step may be optional, if the user already provides consent for automatic onboarding without confirmation when setting up the trusted zone in step 402.

In step 426, network control device 206 and/or mobile device 210 may onboard network device 204 to the local network.

In step 428, after the onboarding is complete, network control device 206 may trigger mobile device 210 to notify the user that network device 204 has been added. For example, as shown in FIG. 5D, mobile device 210 may display “A new smart speaker has been set up in your bedroom” on UI widget 310.

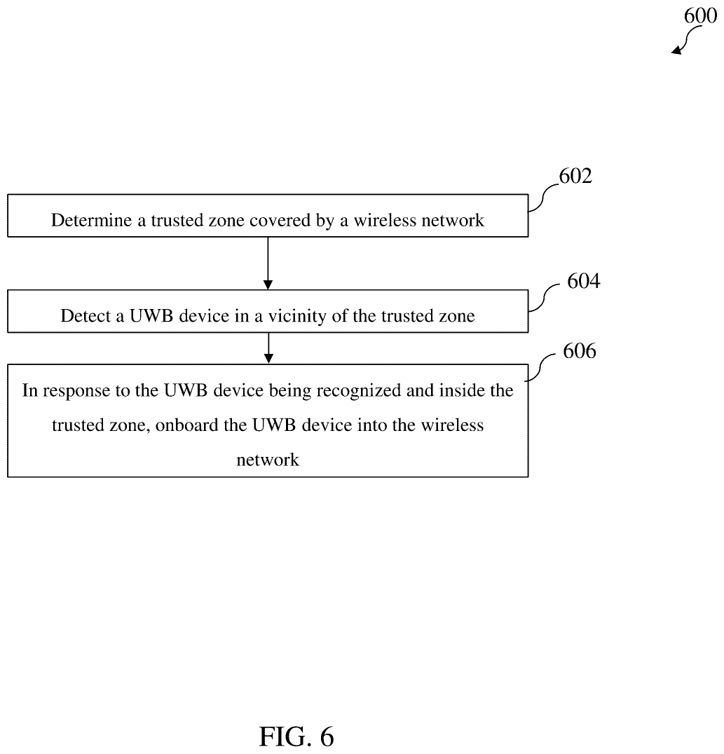

FIG. 6 is a flowchart of a method 600 for a network control device and/or a mobile device to facilitate onboarding a UWB device, according to some embodiments of the present disclosure. Method 600 is merely an example, and is not intended to limit the present disclosure beyond what is explicitly recited in the claims. Additional operations can be provided before, during, and after the method 600, and some operations described can be replaced, eliminated, or moved around for additional embodiments of method 600. For ease of illustration, FIG. 6 is described in connection with FIGS. 2A-2F, 3A-3C, 4A, and 4B.

At step 602, a trusted zone covered by a wireless network is determined. Referring back to the description of FIGS. 2A-2F, and 3A-3C, mobile device 210 may receive a user's input to configure a trusted zone through network control device 206 and/or mobile device 210.

At step 604, a UWB device is detected in a vicinity of the trusted zone. Referring back to the description of FIGS. 2A, 4A, and 4B, network control device 206 may detect the device ID of network device 204 through BLE advertising, and may determine the position of network device 204 based on UWB ranging and the configuration parameters of the trusted zone.

At step 606, if the UWB device is recognized and inside the trusted zone, the UWB device is onboarded into the wireless network. Referring back to the description of FIGS. 2A, 4A, and 4B, network control device 206 may onboard network device 204 if network control device 206 finds a match of the device ID in a device information database, and determines network device 204 is located within the trusted zone.

Those skilled in the art will recognize improvements and modifications to the preferred embodiments of the present disclosure. All such improvements and modifications are considered within the scope of the concepts disclosed herein and the claims that follow.

What is claimed is:

1. A method for onboarding an electronic device in a wireless network, comprising:
determining a trusted zone covered by the wireless network;
detecting the electronic device in a vicinity of the trusted zone; and
in response to the electronic device being recognized and inside the trusted zone, onboarding the electronic device into the wireless network.

2. The method of claim 1, wherein the determining of the trusted zone comprises determining a stationary trusted zone or determining a mobile trusted zone.

3. The method of claim 2, wherein:
the determining of the stationary trusted zone comprises receiving a first configuration parameter and storing the first configuration parameter in a memory; and
the first configuration parameter comprises at least one of a perimeter-center distance from a stationary center, and angle to the stationary center, or an angle at the stationary center.

4. The method of claim 3, wherein the stationary trusted zone comprises at least one of an area encompassing the stationary center or an area originating from the stationary center.

5. The method of claim 3, wherein the receiving of the first configuration parameter comprises at least one of:
receiving, via a user interface (UI) widget, the perimeter-center distance and the angle at the stationary center;
receiving, via the UI widget, the perimeter-center distance and the angle at the stationary center on a displayed floor map covered by the wireless network; or
receiving, via the UI widget, perimeter-center distance and the angle to the stationary center on an augmented reality (AR) presentation of an area covered by the wireless network.

6. The method of claim 3, wherein the stationary center comprises at least one of a hub, a router, a modem, a television, a set-top box, a smart speaker, or a range extender.

7. The method of claim 2, wherein:
the determining of the mobile trusted zone comprises receiving a second configuration parameter and storing the second configuration parameter in a memory; and
the second configuration parameter comprises at least one of a perimeter-center distance from a mobile center or an angle from the mobile center.

8. The method of claim 7, wherein the mobile trusted zone comprises at least one of an area encompassing the mobile center or an area originating from the mobile center.

9. The method of claim 7, wherein the mobile center comprises a mobile device with an imaging device.

10. The method of claim 1, wherein the detecting of the electronic device comprises detecting a beacon signal of the electronic device, the beacon signal comprising a device identification (ID) of the electronic device.

11. The method of claim 10, further comprising:
comparing the device ID to a device information database;
determining the device to be recognized in response to locating a match to the device ID in the device information database; and
determining the device to be unrecognized in response to locating no match to the device ID in the device information database.

12. The method of claim 1, wherein in response to the electronic device being unrecognized, presenting, via a user interface (UI) widget, a prompt to onboard the electronic device using at least one of Bluetooth, near field communication (NFC), or QR code.

13. The method of claim 2, further comprising:
in response to the electronic device being recognized, initiating an ultra-wideband (UWB) ranging with the electronic device; and
determining a location of the electronic device in respect with the stationary center and the mobile center based on the UWB ranging, and respective configuration parameter of each of the stationary center and the mobile center.

14. The method of claim 13, in response to the electronic device being in at least one of the stationary trusted zone or the mobile trusted zone, presenting, via a user interface (UI) widget, a prompt to request onboarding the electronic device.

15. The method of claim 13, in response to the electronic device being in at least one of the stationary trusted zone or the mobile trusted zone, automatically onboarding the electronic device.

16. The method of claim 13, in response to the electronic device not being in the stationary trusted zone or the mobile trusted zone, presenting, via a user interface (UI) widget, a prompt to adjust a position of the mobile center such that the electronic device is located in the mobile trusted zone.

17. The method of claim 16, wherein the adjusting the position of the mobile center comprises at least one of moving the mobile center towards the electronic device or changing an orientation of the mobile center to face the electronic device.

18. The method of claim 16, further comprising initiating another UWB ranging with the electronic device to determine a location of the electronic device with respect to the mobile center after presenting the prompt based on the UWB ranging and respective configuration parameter of the mobile trusted zone.

19. The method of claim 18, wherein in response to the electronic device being outside the mobile trusted zone after the prompt, presenting, via a user interface (UI) widget, another prompt to onboard the electronic device using at least one of Bluetooth, near field communication (NFC), or QR code.

20. An electronic device, comprising:
a transceiver operable to perform an ultra-wideband (UWB) communication;
a memory for storing program instructions, device information, configuration parameters, angle-of-arrivals and distances from the ranging operations; and
a processor coupled to the transceiver and to the memory, wherein the processor is operable to execute the program instructions, which, when executed by the processor, cause the electronic device to perform the following to onboard another electronic device into a wireless local network:
determining a trusted zone covered by the wireless network;
detecting the other electronic device in a vicinity of the trusted zone; and
in response to the other electronic device being recognized and inside the trusted zone, onboarding the other electronic device into the wireless network.
